(19) United States
(12) Patent Application Publication
(10) Pub. No.: US 2023/0134006 A1
(43) Pub. Date: May 4, 2023

(54) SYSTEM AND METHOD OF OPERATING A MOBILE INDUSTRIAL MACHINE

(71) Applicant: Caterpillar Paving Products Inc., Brooklyn Park, MN (US)

(72) Inventor: Jonathan A. ANDERSON, Maple Grove, MN (US)

(73) Assignee: Caterpillar Paving Products Inc., Brooklyn Park, MN (US)

(21) Appl. No.: 17/515,071

(22) Filed: Oct. 29, 2021

(51) Int. Cl. F15B 11/16; E01C 19/48; F15B 21/08

(52) U.S. Cl. CPC F15B 11/165; E01C 19/48; F15B 21/087; F15B 2211/20515; F15B 2211/7135; F15B 2211/6313

(57) ABSTRACT

A method of operating a mobile industrial machine including an electric motor and a hydraulic motor for driving a common load may include receiving a desired drive request for the electric motor to drive the common load, driving the electric motor based on the desired drive request, sensing that the electric motor is unable to provide the full amount of the desired drive request, and driving the hydraulic motor to fulfill the full amount of the desired drive request.

### TECHNICAL FIELD

The present disclosure relates generally to operating a mobile industrial machine, and more particularly, to a mobile industrial machine having an electric motor and a hydraulic motor driving a common load.

### BACKGROUND

A paver machine may be a mobile industrial machine that lays asphalt. A front of the paver machine may have a hopper to store asphalt. A conveyor may transport asphalt from the hopper to an auger, which may rotate to spread the asphalt on a ground surface. A rear of the paver machine may include a screed to smooth the laid asphalt. Large torque loads may exist when starting to drive the conveyor (e.g., in cold weather or to unbind or break up hardened asphalt), and/or when the first dump of asphalt is provided to the machine.

U.S. Pat. No. 10,718,100, issued on Jul. 21, 2020 (“the '100 patent”), describes a hydraulic system for a feed delivery unit. The hydraulic system may include a plurality of hydraulic motors fluidly coupled to a pump and each configured to drive a respective auger of the feed delivery unit. The plurality of hydraulic motors may be connected in series.

Methods and systems of the present disclosure may solve one or more problems in the art. The scope of the current disclosure, however, is defined by the attached claims, and not by the ability to solve any specific problem.

### SUMMARY

In one aspect, a method of operating a mobile industrial machine including an electric motor and a hydraulic motor for driving a common load may include receiving a desired drive request for the electric motor to drive the common load, driving the electric motor based on the desired drive request, sensing that the electric motor is unable to provide the full amount of the desired drive request, and driving the hydraulic motor to fulfill the full amount of the desired drive request. The driving of the hydraulic motor may be a function of an amount of the desired drive request the electric motor is unable to provide.

The method may further include sensing that the electric motor is able to provide the full amount of the desired drive request and discontinuing the driving of the hydraulic motor. Driving the electric motor may drive a shaft, and driving the hydraulic motor may drive the shaft to add torque to the shaft. The desired drive request may be an electric motor speed request. The hydraulic motor may be a fixed displacement motor. The electric motor may be rated to be unable to meet all desired drive requests.

The mobile industrial machine may be a paver machine, and the common load may be a driven component of a paver machine. The driven component may be a conveyor of the paver machine.

In another aspect, a method of operating a mobile industrial machine including an electric motor and a hydraulic motor for driving a common load may include receiving a desired drive request to drive the common load, determining that the electric motor is unable to drive the common load according to the desired drive request, and driving the electric motor and the hydraulic motor to rotate an output shaft coupled to the common load according to the desired drive request.

Determining that the electric motor is unable to fulfil the desired drive request may include determining that a maximum rotational speed of the electric motor is unable to rotate the output shaft according to the desired drive request. Determining that the electric motor is unable to fulfil the desired drive request may include receiving a rotational speed of the electric motor and determining that the received rotational speed is unable to rotate the output shaft according to the desired drive request.

The mobile industrial machine may be a paver machine, and the common load may be a driven component of the paver machine. The driven component may be a conveyor of the paver machine.

The method may further include receiving an additional desired drive request, determining that the electric motor is able to drive the common load according to the additional desired drive request, and discontinuing the driving of the hydraulic motor. Driving the hydraulic motor may include varying a speed of the hydraulic motor.

In another aspect, a control system may be configured to control driving a common load of a mobile industrial machine including an electric motor and a hydraulic motor for driving the common load. The system may include a controller configured to receive a desired drive request for the electric motor to drive the common load, drive the electric motor based on the desired drive request, sense that the electric motor is unable to provide the full amount of the desired drive request, and drive the hydraulic motor to fulfill the full amount of the desired drive request.

The system may include a user interface. The desired request may be received from the user interface. The mobile industrial machine may be a paver machine. The common load may be a driven component of a paver machine. The driven component may be a conveyor configured to transport asphalt.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 schematically illustrates a mobile industrial machine in the form of a paver machine having a conveyor drive system, according to aspects of the disclosure.

FIG. 2 is a schematic diagram illustrating a controller of the paver machine of FIG. 1.

FIG. 3 provides a flowchart depicting an exemplary method for operating the paver machine of FIG. 1.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

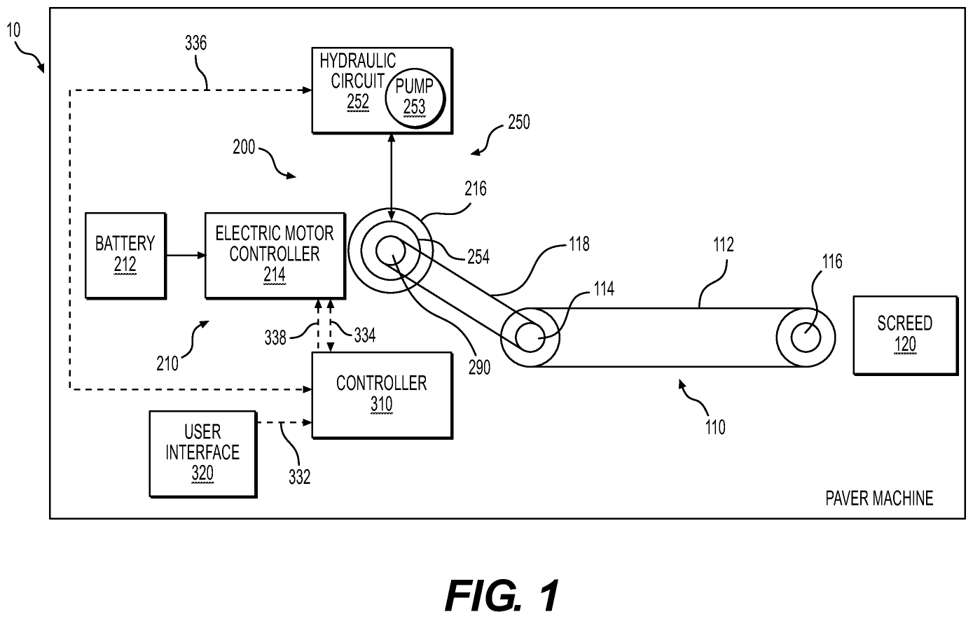

FIG. 1 illustrates a mobile industrial machine 10. The mobile industrial machine 10 could be any industrial machine 10 which moves or is propelled by an engine, such as a compactor, tractor, wheel loader, paver, back hoe loader, etc. For convenience of description, the mobile industrial machine 10 will be described herein as a paver machine 10.

The paver machine 10 may include components such as a conveyor 110, an auger (not shown), a hopper (not shown), a screed 120, and an operator cabin (not shown), and the paver machine 10 may further include a conveyor drive system 200 to drive the conveyor 110. The conveyor drive system 200 may include an electric motor system 210 driven by a power source 212 (e.g., battery) and a hydraulic motor system 250. A controller 310 may control the conveyor driver system 200 based on, among other things, operator commands from a user interface 320 provided in the operator cabin.

The conveyor 110 may receive asphalt from the hopper and transport asphalt or other paving material from the hopper to the auger. The hopper may store and/or dispense asphalt or other paving material, and the auger may be a rod formed with a spiral propeller which rotates to spread the asphalt. The screed 120 may further heat and smooth the asphalt down on the ground.

The conveyor 110 may be driven by the conveyor drive system 200 to transport asphalt from the hopper to the auger. The conveyor 110 may include a conveyor belt 112, a pair of conveyor wheels or rollers 114, 116, and a chain, belt, or other drive connection 118.

The conveyor belt 112 may be a closed loop rotating around the pair of conveyor rollers 114, 116 to transport asphalt. The pair of conveyor rollers 114, 116 may include a driven wheel or roller 114 and a passive wheel or roller 116. Alternatively, both rollers 114, 116 may be driven. The drive roller 114 and the passive roller 116 may be provided at opposite sides of the conveyor belt 112 to support the conveyor belt 112 and/or maintain a tension of the conveyor belt 112. The chain 118 may couple the driven roller 114 to the conveyor drive system 200 such that the electric motor system 210 and the hydraulic motor system 250 drive the conveyor 110 via the chain 118 and driven roller 114. It is understood that other connections 118 are possible, including direct shaft couplings.

As noted above, conveyor drive system 200 may include the electric motor system 210, the hydraulic motor system 250, and an output shaft 290. The electric motor system 210 and the hydraulic motor system 250 may be combined in parallel. The electric drive system 210, connected to battery 212, may primarily drive the conveyor 110. The electric drive system 210 may include the battery 212, an electric motor controller 214, and an electric motor 216.

The battery 212 may power the electric motor controller 214 and the electric motor 216. Although a battery 212 is described as being the power source for the electric motor 216, alternatively, other electric power sources (e.g., a fuel cell, internal combustion engine generator, etc.) may be used in place of or in addition to battery 212. The electric motor controller 214 may be connected to the controller 310 to exchange data back and forth, including receiving commands from the controller 310 for control and operation of the electric motor 216. The electric motor controller 214 may form a part of electric motor 216 and may include a printed circuit board (PCB) and other controller hardware (e.g., communication module, memory, storage, etc.).

The electric motor 216 may rotate the output shaft 290 to drive the conveyor 110. The electric motor 216 may be a permanent magnet motor, an inverter drive, an alternating current (AC) induction motor having a rotor and stator (not shown), etc. The electric motor controller 214 may include an AC/DC converter, but aspects disclosed herein are not limited. The electric motor 216 may have a variable speed. The electric motor 216 may be limited in a speed or rotational speed (e.g., rotations per minute (rpm)), output torque, and/or a power produced, and/or may be rated as being unable to meet all possible torque loads of the conveyor 110, and or desired speed requests received from the user interface 320 and/or received from the controller 310 and electric motor controller 214 in connection with the conveyor 110. For example, the electric motor 216 may have a peak or maximum horsepower or output torque which is insufficient to initially start the conveyor 110, due to the need to unbind or break up hardened asphalt, or during a first dump of asphalt into the hopper and received on the conveyor 110, or when there may otherwise be a higher load on the conveyor 110 (e.g., by a weight of asphalt, friction, etc.)

The hydraulic motor system 250 may assist a driving of the conveyor 110. The hydraulic motor system 250 may include a hydraulic circuit 252 and a hydraulic motor 254. The hydraulic circuit 252 may be connected to the controller 310 and the hydraulic motor 254 to control the hydraulic motor 254. The hydraulic circuit 252 may include, for example, a pump 253 configured to pump hydraulic fluid and a valve (not shown), for example, a proportional control solenoid driven valve, or other type of controllable valve, etc. to control a flow of the hydraulic fluid to the hydraulic motor 254. The hydraulic circuit 252 may be a dedicated circuit for driving hydraulic motor 254, or may be part of a larger hydraulic circuit providing pressurized hydraulic fluid to other systems of the paver machine 10. The hydraulic circuit 252 may be a closed-loop hydraulic circuit or an open-loop hydraulic circuit.

The hydraulic motor 254 may be a variable displacement motor (e.g., with pistons which receive hydraulic fluid from the pump 253 in the hydraulic circuit 252) to provide a range of assistive force, torque, or power. The hydraulic motor 254 may be connected to the output shaft 290 to assist the electric motor 216 in driving the output shaft 290. For example, the hydraulic motor 254 may have a driven shaft rigidly coupled to or integral with the output shaft 290. The hydraulic motor 254 may provide an additive force, torque, power, or speed to a total force, torque, power, or speed applied to the output shaft 290. The hydraulic motor 254 may have a free-wheeling connection to the output shaft 290 such that the hydraulic motor 254 may freely rotate with the output shaft 290 when fluid is not applied. As an example, the hydraulic motor 254 may be a radial piston free-wheeling motor. Alternatively or in addition thereto, the hydraulic motor 254 may be configured to engage with and disengage from (e.g., via a slip or sprag clutch) the electric motor 216 and/or the output shaft 290. As an alternative to a variable displacement motor, the hydraulic motor 254 may be a fixed displacement motor configured to provide a torque to maintain a desired speed. When the hydraulic motor 254 is a fixed displacement motor, the pump 253 of the hydraulic circuit 252 may be a variable displacement pump.

The output shaft 290 may be connected to the chain 118 to drive the conveyor 110, e.g. via a pair of sprockets on the output shaft 290 and a shaft of the driven roller 114, respectively. As will be described in more detail below, the output shaft 290 may be driven by the electric motor 216, and selectively additionally driven by the hydraulic motor 254 when the loads require additional drive torque. Thus, conveyor 110 may provide a common load driven by both the electric motor 216 and the hydraulic motor 254.

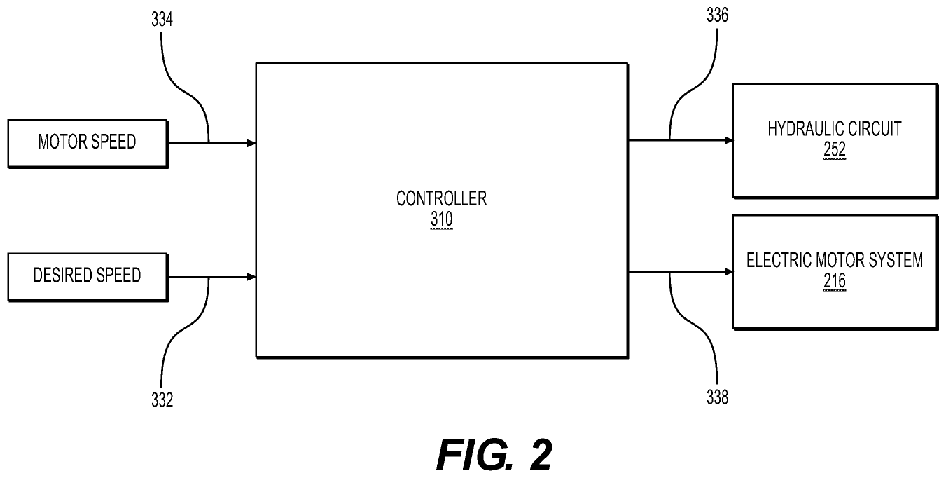

Referring to FIGS. 1-2, the controller 310 may be connected to the electric motor controller 214 and the hydraulic circuit 252 to control the electric motor 216 and the hydraulic motor 254. The controller 310 may receive a plurality of inputs 332, 334, transmit at least one electric motor output 338 to the electric motor controller 214, and transmit at least one hydraulic motor output 336 to the hydraulic circuit 252.

The plurality of inputs 332, 334 may include a desired drive request 332 and an electric motor value 334. The desired drive request 332 may indicate a desired speed (e.g., rpm) of the conveyor drive system 200 (or alternatively, the shaft 290, conveyor belt 112, driven wheel 114, or the electric motor 216) to drive the conveyor 110. The desired drive request 332 may be (or be calculated from) an input from a user at the user interface 320 (FIG. 1) to control the conveyor 110. For example, the user may input a desired speed to drive the conveyor 110 into the user interface 320, which may be indicated by the desired drive request 332. As another example, the user may press an “on” button to start the conveyor 110, which may be converted to a desired drive request 332 indicating a determined or required force, torque, speed, or power to drive the conveyor 110. For convenience of description, the desired drive request 332 transmitted to the controller 310 will be described as a desired speed request, which may alternatively be referred to as an electric motor speed request. However, one of ordinary skill in the art will understand that the desired drive request 332 may be any desired value, command, or input signal from the user, and the controller 310 may determine a value from the desired drive request 332, such as a desired output speed, force, torque (or rotational force), or power.

The electric motor value 334 may indicate an actual speed of the electric motor 216. The electric motor value 334 may be transmitted from a sensor (not shown) configured to measure rpm, a voltage difference, a current, etc. from the electric motor 216. The sensor may be a voltage sensor implemented by a coil wrapped around a conductor carrying current to the electric motor 216, but aspects disclosed herein are not limited. As an alternative to speed, the electric motor value 334 may be an actual output torque, power, etc. calculated from a sensed measurement of the electric motor 216, or an applied torque, power, etc. used to drive the electric motor 216 and/or an amount of power supplied from the battery 212. Alternatively or in addition to the electric motor value 334, the controller 310 may store capability data of the electric motor 216. The capability data may include rating, a known maximum speed, torque, power, etc. of the electric motor 216, e.g., based on the size and type of the electric motor 216. This capability data may be communicated from the electric motor 216 as an additional signal, may be communicated from the user interface 320, or may be pre-stored in the controller 310.

The electric motor output 338 may be a command or signal to the electric motor controller 214 to drive the electric motor 216. The electric motor output 338 may be based on the desired speed request 332. The electric motor output 338 may be, for example, a requested speed of the electric motor 216 and/or an on/off command for the electric motor 216.

The hydraulic motor output 336 may be a command or signal to the hydraulic circuit 252 to drive the hydraulic motor 254. The hydraulic motor output 336 may be, for example, a requested speed of the hydraulic motor 254, or alternatively, an on/off command to the hydraulic circuit 252 and/or hydraulic motor 254. The hydraulic motor output 336 may be a valve command indicating a desired flow of hydraulic fluid to the hydraulic motor 254 and/or indicating a desired opening degree of a valve in the hydraulic circuit 252. The hydraulic motor output 336 may be a function of an amount of the desired speed request 332 that the electric motor 216 is unable to provide. For example, the hydraulic motor output 336 may be proportional to a difference between the actual motor speed 334 and the desired speed request 332. Alternatively or in addition thereto, the hydraulic motor output 336 may be proportional to a difference between a maximum speed of the electric motor 216 stored in or determined by the controller 310 and the desired speed request 332.

The controller 310 may be configured to compare the plurality of inputs 332, 334 to each other and/or with stored capability data to control the hydraulic motor 254 via the hydraulic circuit 252. The controller 310 may determine whether the electric motor 216 is capable of fulfilling or is currently fulfilling the desired speed request 332. For example, the controller 310 may determine that the actual motor speed 334 of the electric motor 216 is less than the desired speed request 332 of the conveyor drive system 200, and determine a speed at which to drive the hydraulic motor 254 to fulfill the desired speed request 332, which may be indicated by the hydraulic motor output 336. As another example, the controller 310 may determine that the maximum motor speed stored in the controller 310 is unable to fulfill the desired speed request 332, and determine the speed at which to drive the hydraulic motor 254, which may be indicated by the hydraulic motor output 336.

Systems and methods disclosed herein are not limited to a specific calculation occurring in the controller 310 and/or specific formats and values of the inputs 332, 334, electric motor output 338, and hydraulic motor output 336. One of ordinary skill in the art will understand that the controller 310 may be configured to convert and/or calculate from the inputs 332, 334 values which are readily comparable, and determine the hydraulic motor output 336 appropriate for the hydraulic circuit 252 and/or the hydraulic motor 254. For example, the hydraulic motor output 336 may indicate an amount or pressure of hydraulic fluid to be supplied to the hydraulic motor 254, a degree of opening of a valve, etc. As another example, the hydraulic motor output 336 may indicate a command for the hydraulic motor 254 to engage with and/or disengage from the electric motor 216, to speed up the hydraulic motor 254, etc. As another example, the plurality of inputs 332, 334 may include multiple sensed values in relation to the electric motor 216 and/or output shaft 290. For example, the controller 310 may receive a torque or power applied to the electric motor 216 and an actual rpm of the output shaft 290, determine that the torque or power applied to the electric motor 216 is relatively high and/or that an actual rpm of the output shaft 290 is relatively low compared to an expected rpm at the applied torque or power, and provide an appropriate output 336 to the hydraulic circuit 252. The controller 310 may also determine acceleration from the inputs 332, and 334.

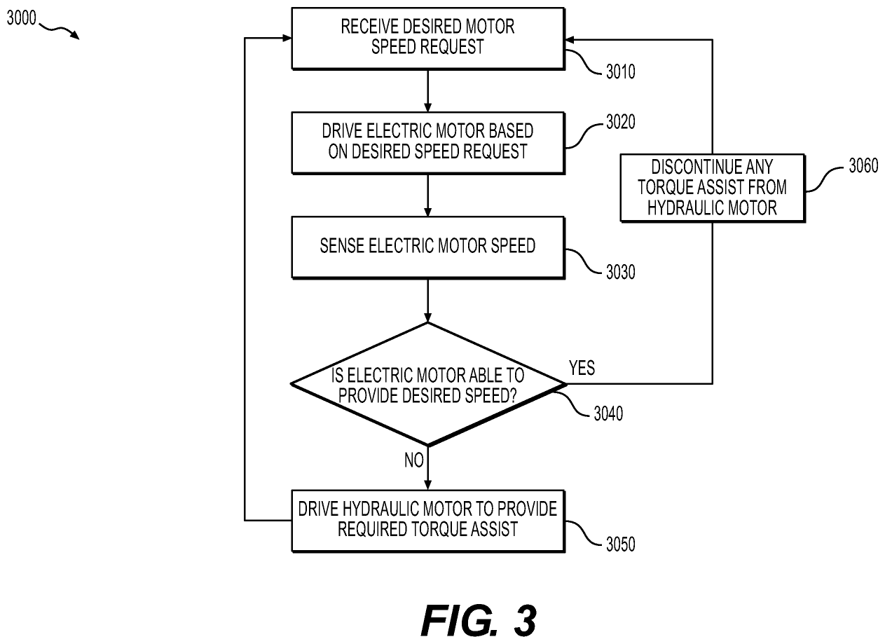

As previously explained, the controller 310 may have a memory or electronic storage which stores the maximum speed or other capability or rating data of the electric motor 216. The controller 310 may be configured to collect performance data of the electric motor 216, store performance data in the memory, and determine a maximum speed of the electric motor 216 from this data, which may be used as (or used in a calculation to determine) input 334. The controller 310 may also include software configured to perform operations shown in FIG. 3. The controller 310 may include a PCB, a processor, and other circuitry components to facilitate these operations. Numerous commercially available microprocessors can be configured to perform the functions of controller 310. It should be appreciated that controller 310 could readily embody a general machine controller capable of controlling numerous other machine functions. Various other known circuits may be associated with controller 310, including signal-conditioning circuitry, communication circuitry, hydraulic or other actuation circuitry, and other appropriate circuitry. Additionally, the controller 310 may be configured to send and receive information through wired means or wireless means.

The user interface 320 may be used to control the paver machine 10 and may include input and output keys, buttons, steering wheels, joysticks, displays, lights, a touch screen, etc. to input various commands and/or display various operations, such as relating to a movement of the paver machine 10 or a paving operation, and/or specific operations of the conveyor 110, auger, hopper, screed 120, etc. The user interface 320 may be configured to convert an input command from a user to the desired speed request 332 (e.g., in a form of a signal) in a particular format or value for the controller 310. The user interface 320 may have a wired connection to the controller 310, but systems and methods disclosed herein are not limited. For example, the user interface 320 and controller 310 may have communication modules capable of wireless communication (e.g., WiFi or Bluetooth modules, etc.) As another example, the user interface 320 may be a remote or mobile device (e.g., laptop or mobile phone) and/or receive input from a remote or mobile device.

### INDUSTRIAL APPLICABILITY

The disclosed aspects of the mobile industrial machine of the present disclosure may be used to provide a hydraulic assistive force to a conveyor when an electric motor is unable to handle or efficiently handle high loads or torques. For example, an electric motor may not be able to efficiently start a conveyor 110, even while operating at peak torques. As another example, the electric motor may not be able to drive the conveyor 110 at a desired speed due to an extra frictional force on the conveyor 110, such as with large asphalt loading and/or sticking to the conveyor belt 112 and/or other surfaces of the paver machine.

Systems and methods disclosed herein may be less expensive by combining motor and drive systems which are smaller in size instead of using larger drive systems. For example, the conveyor drive system 200 may not require a very large electric motor system 210 because the conveyor drive system 200 also includes a hydraulic motor system 250. Systems and methods disclosed herein may provide for a smaller paver machine 10 or other mobile industrial machine because a drive system 200 may be more compact and smaller.

Referring to FIGS. 1-3, aspects and methods disclosed herein may provide a method 3000 for operating the paver machine 10 to drive the conveyor 110. The method 3000 may include, in step 3010, receiving a desired request 332. As noted above, the desired drive request 332 may be a desired motor speed request indicating a desired speed (e.g., rpm) of the electric motor 216, conveyor drive system 200 and/or shaft 290. The desired request 332 may alternatively indicate other desired outputs of the conveyor drive system 200, such as an output torque or power used to drive the conveyor belt 112.

The method 3000 may include, in step 3020, driving the electric motor 216 based on the desired drive request 332. Driving the electric motor 216 may include sending the electric motor command or signal 338 to the electric motor controller 214 indicating a certain speed for the electric motor 216, a torque or power applied to the electric motor 216, etc. The electric motor controller 214 may control and/or communicate with the electric motor 216 based on the electric motor command 338.

The method 3000 may include, in step 3030, sensing or determining an electric motor speed 334 of the electric motor 216. The electric motor speed 334 may indicate an actual speed of the electric motor 216 sensed by a sensor (e.g., voltage sensor).

The method 3000 may include, in step 3040, determining whether the electric motor 216 is able to provide a full amount of the desired drive request 332 based on the sensed electric motor speed 334. The controller 310 may determine whether the electric motor 216 is able to fulfil the desired drive request 332 by comparing the desired drive request 332 with the sensed or determined electric motor speed 334. As previously explained, methods and systems disclosed herein are not limited to specific calculations occurring in the controller 310.

In step 3040, determining whether the electric motor 216 is able to fulfil the desired drive request 332 may alternatively or additionally include comparing the desired drive request 332 with capability data (e.g., a maximum speed or rating). For example, the controller 310 may, before step 3030, first determine whether the electric motor 216 is able to fulfil the desired drive request 332 by comparing the desired drive request 332 with a maximum speed of the electric motor 216 stored in the memory of the controller 310 or determined by the controller 310 based on other stored capability data. If the controller 310 determines that the rating and/or maximum speed of the electric motor 216 is unable to fulfil the desired drive request 332, then the controller 310 does not need to receive the electric motor speed 332 in step 3030.

If, in step 3040, it is determined that the electric motor 216 is unable to provide the full amount of the desired request 332 (“No” after step 3040), then the method 3000 may include, in step 3050, driving the hydraulic motor 254. The hydraulic motor 254 may be driven to provide an assistive speed, torque, or power to drive the conveyor 110. Driving the hydraulic motor 254 may include driving the hydraulic motor 254 at a predetermined speed, torque, power, etc. to provide a determined assistive torque to drive the conveyor 110 to meet the desired drive request 332. The driving the hydraulic motor 254 may be a function of an amount of the desired drive request 332 that the electric motor 216 is unable to provide. Alternatively, driving the hydraulic motor 254 may include turning on and/or engaging the hydraulic motor 254 with the electric motor 216. The hydraulic motor 254 may be configured to provide a majority of the desired speed request 332 during peak loads, such as in a range of up to 60-70% of the full amount, but aspects disclosed herein are not limited.

If, in step 3040, it is determined that the electric motor 216 is able to provide the full amount of the desired drive request 332 (“Yes” after step 3040), then the hydraulic motor 254 may not be driven in step 3060.

Some or all of the steps 3010-3060 of the method 3000 may be repeated. For example, the method 3000 may continuously receive a desired motor speed request 332 in step 3010. If a user has not input a “stop” request or a different request from a previously input desired motor speed request 332, then the controller 310 may continuously receive or consider the same desired motor speed request 332 at this step 3010, drive the electric motor 216 based on the received desired motor speed request 332 in step 3010, and repeat sensing the electric motor speed in step 3030. Alternatively, after step 3050, if no other desired drive requests 332 are input, the method 3000 may be repeated beginning with step 3030 of sensing the electric motor speed 334.

If, after repeating step 3040, it is determined that the electric motor 216 is unable to provide or maintain the full amount of the desired speed request 332 (“No” after step 3040), step 3050 of driving the hydraulic motor 254 may be repeated. Depending on a comparison of the desired motor speed request 332 and the electric motor speed 334 in step 3040, driving the hydraulic motor 254 in step 3050 may include increasing or decreasing a torque assist of the hydraulic motor 254 based on the comparison.

If, after repeating step 3040, it is determined that the electric motor 216 is able to provide the full amount of the desired request 332 (“Yes” after step 3040), then step 3060 of not driving the hydraulic motor 254 may include discontinuing any torque assist from the hydraulic motor 254. The hydraulic motor 254 may be turned off, or a torque assist of the hydraulic motor 254 may be gradually decreased. Determining that the electric motor 216 is able to provide the full amount of the desired drive request 332 in step 3040 may include determining that the electric motor 216 is able to maintain a speed indicated by the initial desired drive request 332, even though the electric motor 216 was unable to accelerate to or achieve the initial desired drive request 332.

As an example, although the method 3000 is described as operating a paver machine 10 to drive a conveyor 110, alternatively, the method 3000 may be used to drive any driven component of the paver machine 10. For example, the conveyor drive system 200 may be an auger drive system 200 to drive the auger, a hopper drive system 200 to drive the hopper, or a screed drive system 200 to drive the screed 120. As another example, the paver 10 may include a conveyor drive system 200 to drive the conveyor 110, a separate auger drive system 200 to drive the auger, a separate screed drive system 200 to drive the screed 120, etc., where each drive system 200 includes its own electric motor system 210 and hydraulic motor system 250. As another example, a single drive system 200 may be used to drive multiple driven components (e.g., conveyor 110 and an auger) via a plurality of chains 218 and/or shafts 290, etc.

Although the method 3000 is described as operating a paver machine 10, the method 3000 may alternatively be used to operate other mobile industrial machines to drive a common load. For example, the method 3000 may be used to operate a compactor 10 to drive a compactor vibrator using a compactor vibrator drive system 200. The method 3000 may be used to drive a separate ground drive system 200 in mobile industrial machines (e.g., tractors).

Aspects of the present disclosure may provide a drive system including both an electric motor and a hydraulic motor to assist the electric motor to drive a common load. A control system may control the drive system according to one or more inputs indicating a desired request (e.g., a speed or output torque of the drive system) and one or more inputs indicating current or actual data of the common load (e.g., an actual speed of the drive system or of the electric motor). Aspects of the present disclosure may drive the common load primarily using an electric motor, and may control a hydraulic motor to provide an assistive torque when the electric motor is incapable of handling the common load or where driving only the electric motor would otherwise be inefficient. The hydraulic motor may provide an additive force, torque, power, or speed to that of the electric motor to increase a total torque, power, and/or speed provided by the drive system.

Aspects of the present disclosure may provide a way to handle infrequent maximum torque needs for an industrial mobile machine (e.g., paver machine). Aspects of the present disclosure may provide a drive system capable of handling sporadic peak requirements without requiring a larger or more expensive electric drive system or electric motor. For example, in a conveyor drive system configured to drive a conveyor, the conveyor may be typically pull about 1500 pounds per square inch (psi), but may have a maximum operating pressure of about 4000 psi. The drive system may include an electric drive system configured to drive the conveyor at typical pressures like 1500 psi or about ⅓ of the maximum power required, while the hydraulic drive system may be configured to assist driving the conveyor at maximum operating pressures. The electric drive system may provide the necessary power most of the time (e.g., 95% of the time), while the hydraulic drive system may assist during more infrequent instances where power power is required to drive the conveyor.

It will be apparent to those skilled in the art that various modifications and variations can be made to the disclosed method and system without departing from the scope of the disclosure. Other embodiments of the method and system will be apparent to those skilled in the art from consideration of the specification and practice of the systems disclosed herein. For example, why a hydraulic motor 254 and associated hydraulic circuit 252 is described above, it is understood that alternative additional drive systems may be provided, such as a different fluid drive such as a pneumatic drive system and associated motor. It is intended that the specification and examples be considered as exemplary only, with a true scope of the disclosure being indicated by the following claims and their equivalents.

What is claimed is:

1. A method of operating a mobile industrial machine including an electric motor and a hydraulic motor for driving a common load, the method comprising:
receiving a desired drive request for the electric motor to drive the common load;
driving the electric motor based on the desired drive request;
sensing that the electric motor is unable to provide the full amount of the desired drive request; and
driving the hydraulic motor to fulfill the full amount of the desired drive request.

2. The method of claim 1, wherein the driving of the hydraulic motor is a function of an amount of the desired drive request the electric motor is unable to provide.

3. The method of claim 1, further comprising:
sensing that the electric motor is able to provide the full amount of the desired drive request, and
discontinuing the driving of the hydraulic motor.

4. The method of claim 1, wherein driving the electric motor drives a shaft, and driving the hydraulic motor drives the shaft to add torque to the shaft.

5. The method of claim 1, wherein the desired drive request is an electric motor speed request.

6. The method of claim 1, wherein the hydraulic motor is a fixed displacement motor.

7. The method of claim 1, wherein the electric motor is rated to be unable to meet all desired drive requests.

8. The method of claim 1, wherein the mobile industrial machine is a paver machine, and the common load is a driven component of a paver machine.

9. The method of claim 8, wherein the driven component is a conveyor of the paver machine.

10. A method of operating a mobile industrial machine including an electric motor and a hydraulic motor for driving a common load, the method comprising:
receiving a desired drive request to drive the common load;
determining that the electric motor is unable to drive the common load according to the desired drive request; and
driving the electric motor and the hydraulic motor to rotate an output shaft coupled to the common load according to the desired drive request.

11. The method of claim 10, wherein determining that the electric motor is unable to fulfil the desired drive request includes determining that a maximum rotational speed of the electric motor is unable to rotate the output shaft according to the desired drive request.

12. The method of claim 10, wherein determining that the electric motor is unable to fulfil the desired drive request includes receiving a rotational speed of the electric motor and determining that the received rotational speed is unable to rotate the output shaft according to the desired drive request.

13. The method of claim 10, wherein the mobile industrial machine is a paver machine, and the common load is a driven component of the paver machine.

14. The method of claim 13, wherein the driven component is a conveyor of the paver machine.

15. The method of claim 10, further comprising:
receiving an additional desired drive request,
determining that the electric motor is able to drive the common load according to the additional desired drive request, and
discontinuing the driving of the hydraulic motor.

16. The method of claim 10, wherein driving the hydraulic motor includes varying a speed of the hydraulic motor.

17. A control system configured to control driving a common load of a mobile industrial machine including an electric motor and a hydraulic motor for driving the common load, the system comprising:
a controller configured to:
receive a desired drive request for the electric motor to drive the common load;
drive the electric motor based on the desired drive request;
sense that the electric motor is unable to provide the full amount of the desired drive request; and
drive the hydraulic motor to fulfill the full amount of the desired drive request.

18. The system of claim 17, further comprising a user interface, wherein the desired request is received from the user interface.

19. The system of claim 17, wherein the mobile industrial machine is a paver machine, and the common load is driven component of a paver machine.

20. The system of claim 19, wherein the driven component is a conveyor configured to transport asphalt.
